(19) United States
(12) Patent Application Publication
(10) Pub. No.: US 2018/0188535 A1
(43) Pub. Date: Jul. 5, 2018

(54) Combiner Head-Up Display

(71) Applicant: Continental Automotive Systems, Inc., Auburn Hills, MI (US)

(72) Inventors: Luis Ernesto Quiroz de la mora, Tlaquepaque (MX); Johan Gomez Martinez, Zapopan (MX)

(73) Assignee: Continental Automotive Systems, Inc., Auburn Hills, MI (US)

(21) Appl. No.: 15/396,545

(22) Filed: Dec. 31, 2016

(51) Int. Cl. G02B 27/01; F16H 19/06; B60K 35/00

(52) U.S. Cl. CPC G02B 27/0149; G02B 27/0101; F16H 19/06; F16H 1/14; G02B 2027/0154; G02B 2027/0163; F16H 2019/0686; B60K 35/00

(57) ABSTRACT

A combiner head-up display (HUD) system is provided. The combiner HUD system includes a combiner mirror, a combiner holder configured to support the combiner mirror, a combiner housing configured to house the combiner holder, and a linear slide rail supported by the combiner housing. The combiner HUD system also includes at least one slider releasably attached to the linear slide rail, a first pulley disposed on one end of the linear slide rail, and a coil pulley supported by the combiner housing. The combiner HUD system also includes a wire wrapped around the first pulley and the coil pulley, and a motor configured to rotate the coil pulley. A rotation of the coil pulley causes a rotation of the wire causing a movement of the combiner mirror and the combiner holder with respect to the combiner HUD housing.

### TECHNICAL FIELD

This disclosure relates to a combiner head-up display (HUD) for the interior of a motor vehicle.

### BACKGROUND

A head-up display or heads-up display (HUD) is a display that presents data to a user without requiring the user to look away from their usual forward viewpoint(s). The HUD presents information to the user directly in the line of sight of the user, reducing driver distractions. For example, HUDs are used in a vehicle to display information, such as, but not limited to, vehicle speed, speed limit information, and/or navigation information. As such, the user may maintain his head in an upright forward looking position to view the provided information, instead of angling his/her head down and looking at lower instruments (e.g., instrument cluster or secondary display). Therefore, the user's eyes do not have to accommodate between looking inside to a position having a short distance then looking outside at the road having a longer distance. In addition, the user does not need to refocus his view from looking at the lower instruments and then looking at the road.

In some examples, the HUD projects an image onto the windshield of a vehicle. However, based on the design of the windshield and the vehicle, in some examples, it may be difficult to design a HUD that is capable of projecting images on the windshield viewable by the driver due to constraints, for example, distance between the driver and the windshield, the position of the HUD with respect to the windshield, and/or the shape of the windshield. Therefore, it is desirable to have a HUD system configured to fit in any vehicle and provide a display image viewable to the driver regardless of the shape and size of the windshield.

### SUMMARY

One aspect of the disclosure provides a combiner head-up display (HUD) system that includes: a combiner mirror; a combiner holder configured to support the combiner mirror; and a combiner housing configured to house the combiner holder. The combiner HUD system also includes: a linear slide rail supported by the combiner housing; at least one slider releasably attached to the linear slide rail; and a first pulley disposed on one end of the linear slide rail. The combiner HUD system also includes a coil pulley supported by the combiner housing; a wire wrapped around the first pulley and the coil pulley; and a motor configured to rotate the coil pulley. A rotation of the coil pulley causes a rotation of the wire causing a movement of the combiner mirror and the combiner holder with respect to the combiner HUD housing.

Implementations of the disclosure may include one or more of the following optional features. In some implementations, the combiner HUD system further includes: a second pulley disposed on another end of the linear slide rail opposite the one end of the linear slide rail. The wire wraps around the first pulley, the second pulley, and the coil pulley.

In some examples, the motor is configured to rotate the coil pulley in a first direction causing the combiner mirror and the combiner holder to move to a display position and a second direction causing the combiner mirror and the combiner holder to move to a stowed position. The first direction may be a clockwise direction and the second direction may be an anti-clockwise direction, or vice versa. The linear slide rail may include one of ball bearings, dovetail bearings, linear roller bearings, magnetic or fluid bearings.

In some implementations, the combiner HUD system further includes a pin integrally formed with the combiner holder and extending away from the combiner holder. An aperture may be defined by the combiner housing and may be configured to guide the combiner holder when the combiner holder is moving.

The combiner HUD system may also include a first gear attached to the coil pulley and a second gear connector to the motor. The first gear may be configured to mesh with the second gear. In some examples, the first gear is substantially perpendicular to the second gear.

In some implementations, the motor may include one of a finger brush motor, a brushless motor, and a stepper motor. The combiner HUD system may also include an aperture defined by a top portion of the combiner housing. The aperture may be configured to receive the combiner mirror when the combiner mirror is moving with respect to the combiner HUD housing.

In some examples, the motor is connected to a controller configured to receive a command from a driver. The command may be one of an open command configured to rotate the motor in a first direction and a close command configured to rotate the motor in a second direction opposite the first direction.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of an exemplary combiner head-up display in a stowed position.

FIG. 1B is a side view of the exemplary combiner head-up display in a stowed position.

FIG. 2A is a perspective view of an exemplary combiner head-up display in a display position.

FIG. 2B is a side view of the exemplary combiner head-up display in a display position.

Like reference symbols in the various drawings indicate like elements.

### DETAILED DESCRIPTION

Vehicles, such as motor vehicles that include motorcycles, cars, cross-overs, trucks, and buses, railed vehicles that include trains and trams, watercraft vehicles that include ships and boats, and aircrafts have various designs and shapes. In some examples, the vehicle includes a head-up display (HUD) system that helps a driver of the vehicle view information associated with the vehicle or environment of the vehicle while maintaining a field-of-view for driving the vehicle. As such, it is desirable to have a combiner HUD system 100 configured for installation in a dashboard of a vehicle with limited space and for installation in multiple vehicles having different specification (such as size, volume, and placement of different modules within the vehicle). As such, the combiner HUD system 100 is flexible option for being installed in multiple vehicles having different specifications and being independent of the shape of the windshield.

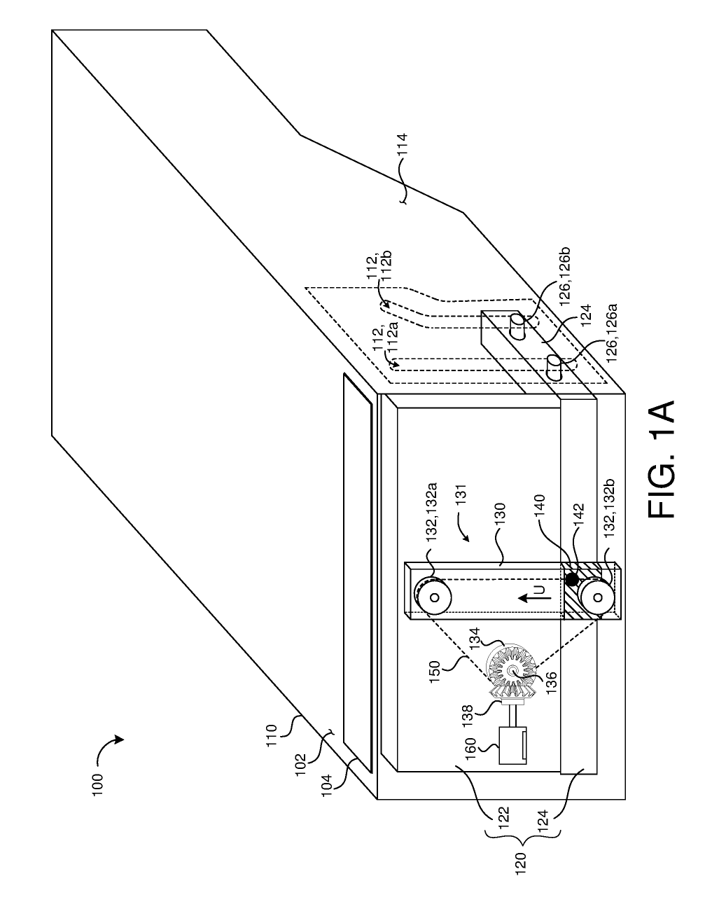

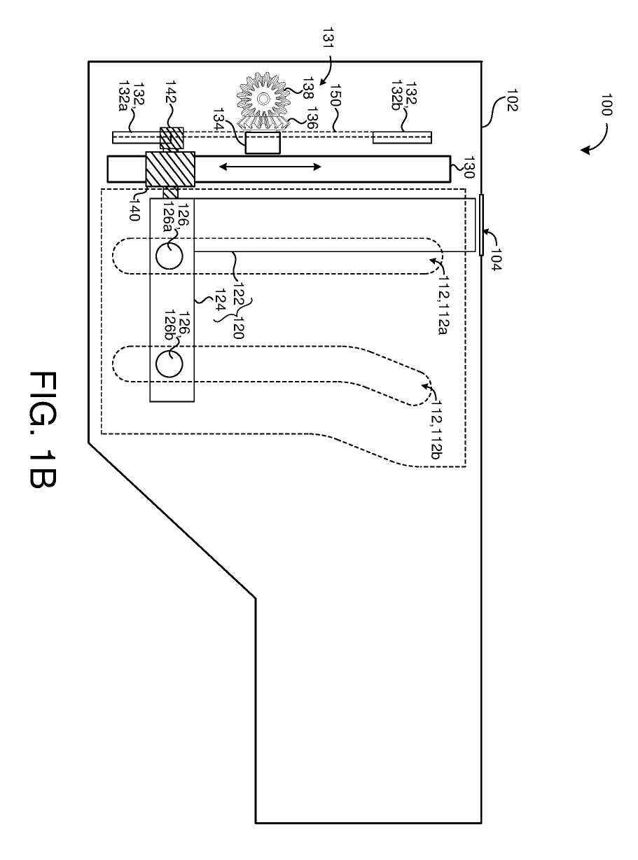

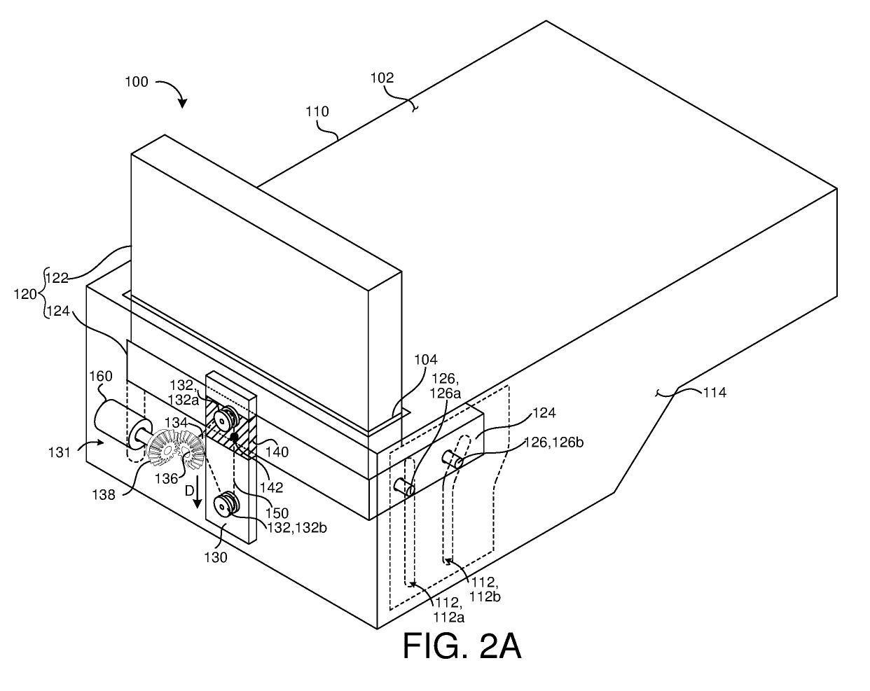

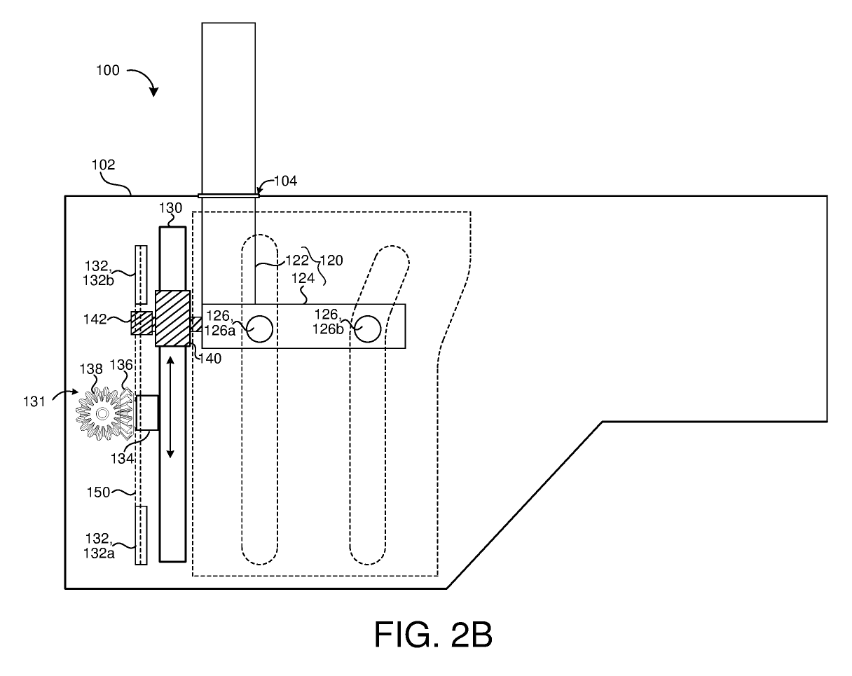

Referring to FIGS. 1A-2B, in some implementations, a vehicle (not shown) includes a combiner head-up display (HUD) system 100. The combiner HUD system 100 is a scalable solution that provides an alternative to an HUD, which reflects an image on a windshield of the vehicle.

As shown, the combiner HUD system 100 includes a combiner HUD housing 110. The combiner HUD housing 110 houses a combiner system 120 that includes a combiner 122 supported by a combiner holder 124. The combiner 122 includes a combiner mirror that reflects images from an image generator (not shown). A top portion 102 of the combiner HUD housing 110 defines an aperture 104 configured to receive the combiner mirror. In some examples, the combiner mirror includes a transparent plastic disc used as the mirror. The combiner holder 124 may be substantially perpendicular to the combiner 122. While in other examples, the combiner holder 124 forms a non-perpendicular angle with the combiner 122. The combiner holder 124 may include at least one pin 126 configured to guide the combiner system 120 as it moves from a stowed position shown in FIGS. 1A and 1B to a display position as shown in FIGS. 2A and 2B and vice versa. In some examples, the pin 126 is integrally formed with the combiner holder 124. The combiner HUD housing 110, specifically a side 114 of the housing defines at least one opening or aperture 112 that receives the at least one pin 126 to guide the pin 126 when moving from the stowed position to the display position and vice versa. As shown, the combiner system 120 includes a first pin 126a and a second pin 126 on one side 114 of the combiner HUD housing 110; however, in some examples, the combiner HUD housing 110 may include any other configuration and number of pins 126 that may be located on the one side 114 of the combiner HUD housing and/or on an opposite side (not shown) of the combiner HUD housing 110 opposite the one side 114.

The combiner HUD system 100 includes a motion system 131 configured to move the combiner system 120 from the stowed position to the display position and vice versa. The motion system 131 includes a linear slide rail 130 supported by the combiner HUD housing 110. The linear slide rail 130 is a bearing designed to provide free motion in one direction. In some examples, the linear slide rail 130 provides motion based on bearings, such as, but not limited to ball bearings, dovetail bearings, linear roller bearings, magnetic or fluid bearings. The motion system 131 also includes a slider 140 releasably attached to the linear slide rail 130. The slider 140 is configured to move vertically along the linear slide rail 130. The slider 140 is releasably connected to the combiner system 120, more specifically to the combiner holder 124. As such, when the slider 140 moves vertically along the slider 140, the movement of the slider 140 causes the combiner system 120 to move in a vertical direction. Therefore, when the slider 140 is in an initial position as shown in FIGS. 1A and 1B, the combiner system 120 is in a stowed position. As the slider 140 moves vertically in an upward direction U along the linear slide rail 130, the combiner system 120 along with the slider 140 also move vertically in the upward direction U causing the combiner system 120 to be in the display position. Similarly, as the slider 140 moves vertically in a downward direction D along the linear slide rail 130, the combiner system 120 along with the slider 140 also move vertically in the downward direction D causing the combiner system 120 to be in the stowed position.

In some examples, the motion system 131 includes first and second pulleys 132, 132a, and 132b, each disposed at one end of the linear slide rail 130. The motion system 131 also includes a coil pulley 134. A wire 150 runs around the first pulley 132a, the second pulley 132b and coils around the coil pulley 134. As such, a movement of the wire 150 in one direction causes the first and second pulleys 132a, 132b, and the coil pulley 134 to rotate in the same direction as the movement of the wire 150.

The motion system 131 also includes a first gear 136 and a second gear 138. The first and second gears 136, 138 may include, but are not limited to, a bevel gear, spur gear, planetary gear, worm gear, Herringbone gear, or any other gear type. The first gear 136 is substantially perpendicular to the second gear 138. The first and second gears 136, 138 mesh with each other. In addition, the second gear 138 is connected to a motor 160 configured to rotate the second gear 138. The first and second gears 136, 138 are used to transfer the motion of the motor 160 from a first axis to a second axis different from the first axis. In some examples, the motor 160 is finger brush type, brushless type, stepper motor type, or any other type of electrical motor. In some examples, the motor 160 may be directly connected to the coil pulley 134, thus avoiding the use of the first and second gears 136, 138 since, in this case, the motor 160 provides the same motion as the motion needed to rotate the coil pulley 134.

In some example, the motor 160 is connected to a controller (not shown) configured to receive a command from the driver. The command being one of an open command configured to rotate the motor 160 in a first direction and a close command configured to rotate the motor 160 in a second direction opposite the first direction.

A rivet 142 connects the wire 150 with the slider 140. Therefore, a movement of the motor 160 causes a movement of the wire 150, which moves the slider 140 and the combiner system 120 vertically along the linear slide rail 130 with the movement of the wire 150.

In the examples shown, the first and second pulleys 132a, 132b and the coil pulley 134 are arranges in a triangular shape with the coil pulley 134 being at a distance between the first and second pulleys 132a, 132b. However, different configurations of the pulleys 132a, 132b, 134 may also be possible. In some example, the motion system 131 may include one pulley 132 and one coil pulley 134, where the coil pulley 134 is disposed at one end of the linear slide rail 130 and the one pulley 132 is disposed at the opposite end of the linear slide rail 130. In this case, the wire 150 wraps around the coil pulley 134 and the one pulley 132 and the motor 160 causes the coil pulley 134 to rotate which causes the one pulley 132 to rotate causing the movement of the slider 140 and the combiner system 120.

In some implementations, during operation, when the combiner system 120 is in a stowed position, the motor 160 receives an open command, the motor 160 rotates in the first direction which causes the second gear 138 to rotate which also causes the first gear 136 to rotate, which in turn causes the coil pulley 134, the first and second pulleys 132a, 132b, and the wire 150 to also rotate. In this case, the first gear 136 and the coil pulley 134 rotate to the left or in a counter-clockwise direction pulling the wire 150 and the slider 140, leading to the slider 140 and the combiner system 120 to move in an upward direction U.

In some implementations, during operation, when the combiner system 120 is in a display position, the motor 160 receives a close command, the motor 160 rotates in the second direction which causes the second gear 138 to rotate which also causes the first gear 136 to rotate, which in turn causes the coil pulley 134, the first and second pulleys 132a, 132b, and the wire 150 to also rotate. In this case, the first gear 136 and the coil pulley 134 rotate to the right or in a clockwise direction pulling the wire 150 and the slider 140, leading to the slider 140 and the combiner system 120 to move in a downward direction D.

A number of implementations have been described. Nevertheless, it will be understood that various modifications may be made without departing from the spirit and scope of the disclosure. Accordingly, other implementations are within the scope of the following claims.

What is claimed is:

1. A combiner head-up display (HUD) system comprising:
a combiner mirror;
a combiner holder configured to support the combiner mirror;
a combiner housing configured to house the combiner holder;
a linear slide rail supported by the combiner housing;
at least one slider releasably attached to the linear slide rail;
a first pulley disposed on one end of the linear slide rail;
a coil pulley supported by the combiner housing;
a wire wrapped around the first pulley and the coil pulley; and
a motor configured to rotate the coil pulley,
wherein a rotation of the coil pulley causes a rotation of the wire causing a movement of the combiner mirror and the combiner holder with respect to the combiner HUD housing.

2. The combiner HUD system of claim 1, further comprising:
a second pulley disposed on another end of the linear slide rail opposite the one end of the linear slide rail, the wire wrapped around the first pulley, the second pulley, and the coil pulley.

3. The combiner HUD system of claim 1, wherein the motor is configured to rotate the coil pulley in a first direction causing the combiner mirror and the combiner holder to move to a display position and a second direction causing the combiner mirror and the combiner holder to move to a stowed position.

4. The combiner HUD system of claim 3, wherein the first direction is a clockwise direction and the second direction is an anti-clockwise direction.

5. The combiner HUD system of claim 1, wherein the linear slide rail comprises one of ball bearings, dovetail bearings, linear roller bearings, magnetic or fluid bearings.

6. The combiner HUD system of claim 1, further comprising:
a pin integrally formed with the combiner holder and extending away from the combiner holder; and
an aperture defined by the combiner housing, the aperture configured to guide the combiner holder when the combiner holder is moving.

7. The combiner HUD system of claim 1, further comprising:
a first gear attached to the coil pulley; and
a second gear connector to the motor, the first gear is configured to mesh with the second gear, the first gear is substantially perpendicular to the second gear.

8. The combiner HUD system of claim 1, wherein the motor may include one of a finger brush motor, a brushless motor, and a stepper motor.

9. The combiner HUD system of claim 1, further comprising an aperture defined by a top portion of the combiner housing, the aperture configured to receive the combiner mirror when the combiner mirror is moving with respect to the combiner HUD housing.

10. The combiner HUD system of claim 1, wherein the motor is connected to a controller configured to receive a command from a driver, the command being one of an open command configured to rotate the motor in a first direction and a close command configured to rotate the motor in a second direction opposite the first direction.
